(19) United States
(12) Patent Application Publication
(10) Pub. No.: US 2026/0300057 A1
(43) Pub. Date: Oct. 1, 2026

(54) Emulation of Unix Pipes in Windows Systems

(71) Applicant: Zscaler, Inc., San Jose, CA (US)

(72) Inventor: Vitaly Vatnikov, Marblehead, MA (US)

(73) Assignee: Zscaler, Inc., San Jose, CA (US)

(21) Appl. No.: 19/089,097

(22) Filed: Mar. 25, 2025

(51) Int. Cl. G06F 9/54; H04L 69/16

(52) U.S. Cl. CPC G06F 9/547; H04L 69/162

(57) ABSTRACT

Systems and methods for emulating Unix pipes on Windows operating systems include creating an emulated pipe by creating a listening Transmission Control Protocol (TCP) socket and a client TCP socket and establishing a local loopback TCP connection between them; utilizing the emulated pipe for inter-process communication by assigning file descriptors to the established TCP connection, wherein a first file descriptor is designated for reading and a second file descriptor is designated for writing; and enabling asynchronous operation by integrating the emulated pipe with event-driven Application Programming Interfaces (APIs), allowing non-blocking communication between processes or threads within an application.

### FIELD OF THE DISCLOSURE

The present disclosure relates generally to computing. More particularly, the present disclosure relates to systems and methods for emulating Unix pipes in Windows systems.

### BACKGROUND OF THE DISCLOSURE

Cross-platform software development presents significant challenges when attempting to replicate Unix-style pipe functionality on systems like Windows, where native support for POSIX pipes is either non-existent or limited in capability. Unix-style pipes are integral to Unix-like systems, enabling efficient, unidirectional communication between processes through a simple and lightweight interface. They are commonly used in real-time, modular, and event-driven applications due to their support for asynchronous I/O and seamless data transfer. However, Windows systems lack direct support for unnamed POSIX pipes with asynchronous functionality, making it difficult to achieve similar performance and behavior. While Windows provides named pipes with advanced features, such as security and duplex communication, they are over-engineered for many simple IPC use cases and introduce additional complexities, such as requiring file-like naming conventions and setup overhead. Moreover, Windows' unnamed pipes, which align conceptually with Unix pipes, lack the robust asynchronous mechanisms provided by POSIX APIs, such as poll() or select(). For developers building cross-platform applications, these inconsistencies not only complicate the design process but also force them to implement platform-specific workarounds, increasing code complexity and reducing maintainability. This lack of parity hampers the ability to create streamlined, efficient, and portable applications, making it essential to devise mechanisms that can emulate Unix-style pipe behavior within the constraints of the Windows operating system.

### BRIEF SUMMARY OF THE DISCLOSURE

The present disclosure includes methods having steps, processing devices configured to implement the steps, a cloud-based system configured to implement the steps, and as a non-transitory computer-readable medium storing instructions for programming one or more processors to execute the steps. The steps include creating an emulated pipe by creating a listening Transmission Control Protocol (TCP) socket and a client TCP socket and establishing a local loopback TCP connection between them; utilizing the emulated pipe for inter-process communication by assigning file descriptors to the established TCP connection, wherein a first file descriptor is designated for reading and a second file descriptor is designated for writing; and enabling asynchronous operation by integrating the emulated pipe with event-driven Application Programming Interfaces (APIs), allowing non-blocking communication between processes or threads within an application.

The steps can further include configuring security measures by reserving a dedicated range of TCP ports and validating incoming connections to ensure they originate from the reserved port range. The reserved TCP port range can be dynamically allocated at runtime based on system availability. The listening TCP socket can be closed after the client TCP socket successfully connects, preventing unwanted external connections. The local loopback TCP connection can be established using a Windows Sockets API. The steps can include implementing a retry mechanism to handle failed connection attempts by reinitializing the emulated pipe with a new TCP port allocation. The event-driven API used for enabling asynchronous operation can include select() or poll() mechanisms. The steps can include dynamically binding the client TCP and listening TCP sockets to distinct ports selected from a pre-reserved TCP port range to ensure predictable and controlled communication. The steps can include detecting an unauthorized process attempting to communicate to a listening TCP port, and dropping the connection based thereon.

### BRIEF DESCRIPTION OF THE DRAWINGS

The present disclosure is detailed through various drawings, where like components or steps are indicated by identical reference numbers for clarity and consistency.

FIG. 1 is a block diagram of a computing system that may be used to implement various components described in this disclosure.

FIG. 2 is a diagram representing components of an emulated Unix pipe.

FIG. 3 is a flowchart representing a process for pipe shim library initialization.

FIG. 4 is a flow diagram representing a pipe setup sequence.

FIG. 5 illustrates a flowchart of a process for emulation of Unix pipes in windows systems.

### DETAILED DESCRIPTION OF THE DISCLOSURE

Again, the present disclosure relates to emulating Unix pipes in Windows systems. The invention addresses a critical challenge in cross-platform software development, specifically the emulation of Unix-style pipes on systems like Windows, where native POSIX pipe functionality is either limited or lacks essential features such as asynchronous communication. Unix pipes are a cornerstone of inter-process communication (IPC) in Unix-like systems, enabling seamless, unidirectional data transfer between processes in a simple and efficient manner. They are widely used in building modular, event-driven, and real-time applications, particularly in environments requiring reliability and scalability, such as cloud-based systems. However, in Windows environments, unnamed pipes do not natively support the asynchronous capabilities that are essential for event-driven architectures and high-performance systems, posing a significant challenge for developers building cross-platform applications. Existing solutions, such as Windows named pipes introduce additional complexity, and are not portable to Linux platforms. This invention overcomes these limitations by leveraging local TCP/IP loopback connections to emulate Unix-style pipes. The design enhances reliability, security, and asynchronous functionality, making it a robust tool for modern, scalable cloud infrastructures while maintaining compatibility with event-driven libraries

### Example Computing System Architecture and Cloud Deployment

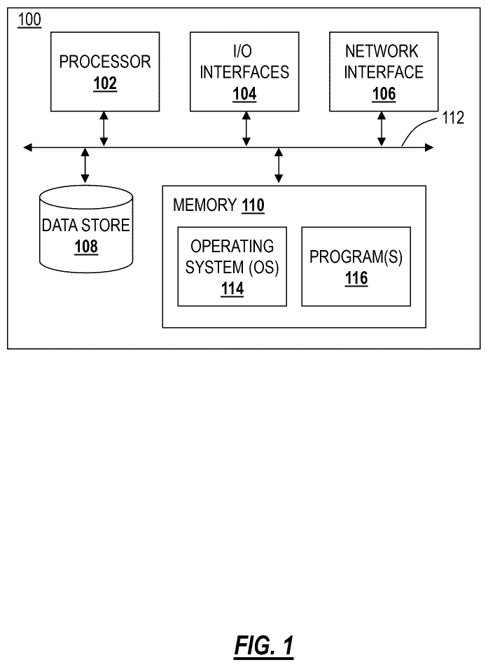

FIG. 1 is a block diagram of a computing system 100 that may be used to implement various components described in this disclosure. The computing system 100 can be implemented in many forms, including laptops, desktops, smartphones, tablets, physical servers, clusters of machines, virtual machines (VMs) running on hypervisors, or serverless computing frameworks. Regardless of the underlying infrastructure, the computing system 100 typically includes one or more processors 102, input/output (I/O) interfaces 104, a network interface 106, a data store 108, and memory 110. Note that FIG. 1 provides a simplified representation; in practice, the computing system 100 may include additional hardware and software elements. These components 102, 104, 106, 108, 110 are connected via a local interface 112, which can include various wired or wireless buses, high-speed interconnects, or switching fabrics. The local interface 112 may also include controllers, buffers, caches, drivers, repeaters, and receivers, along with addressing and control lines that facilitate efficient communication and resource sharing among components.

Each processor 102 is a hardware element—such as a central processing unit (CPU), multicore processor, system-on-chip (SoC), graphics processing unit (GPU), or a processing element within a larger compute cluster—designed to execute software instructions. These processors may be general-purpose or specialized, depending on performance, power efficiency, or workload needs. During operation, each processor 102 retrieves and executes instructions stored in memory 110, manages data exchanges with the data store 108, and oversees system 100 operations. In large-scale environments, multiple processors 102 may operate in parallel to handle elevated traffic and complex workloads.

The I/O interfaces 104 enable the computing system 100 to interact with external peripherals, allowing user input (e.g., via keyboards, touchscreens, or sensors) and system output (e.g., to displays or printers). Depending on the application, these I/O interfaces 104 may also support specialized devices used for maintenance, debugging, or other administrative functions. Meanwhile, the network interface 106 handles connectivity to external networks, which may include the Internet, private networks, or cloud environments. This network interface can use Ethernet, wireless local area networks (LANs), cellular connections, or virtualized cloud interfaces. By using secure transport protocols and encryption, data transmitted via the network interface 106 can remain protected, enabling the computing system 100 to participate safely in distributed or cloud-based deployments.

The data store 108 provides storage for both persistent and temporary data. It may include volatile memory (e.g., random access memory (RAM)) for high-speed operations and nonvolatile media (e.g., solid-state drives, hard disk drives, optical media) for long-term retention. In some deployments, the data store 108 may integrate with network-attached storage (NAS), storage area networks (SAN), or cloud-based storage solutions. These configurations can range from modest local setups to large-scale installations, potentially featuring global deduplication, compression, encryption at rest, and multi-site replication. The data store 108 can hold operational logs, configuration details, policy rules, program binaries, and cached computation results.

The memory 110 typically serves as the primary working memory for the processors 102. It may be composed of volatile elements (e.g., dynamic RAM (DRAM), double data rate (DDR), synchronous DRAM (SDRAM)) for fast access, as well as nonvolatile components such as flash memory or non-volatile RAM (NVRAM). The memory 110 can be distributed across nodes or servers to support the large-scale in-memory processing demanded by modern cloud services. Generally, the memory 110 stores the operating system (O/S) 114 and one or more programs 116. The O/S 114 handles core system tasks such as process scheduling, memory allocation, file management, and networking.

For Software-as-a-Service (SaaS) or other cloud-based components, the computing system 100 can be deployed in various ways: as a private cloud in a single organization's datacenter, a public cloud hosted by a third-party provider, or a hybrid cloud that combines both approaches for specific security, performance, or compliance considerations. Cloud computing abstracts physical hardware—servers, storage devices, and networks—into on-demand, scalable resources. This allows organizations to provision computing power, storage, and network bandwidth with minimal upfront costs, adjusting to fluctuating workloads seamlessly. According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing application hosting allows providers to uniformly release new features, apply security patches, and manage licensing. By using these SaaS models, end users can access software via browsers or lightweight clients, taking advantage of continuous improvements and frequent updates.

Various embodiments may utilize different forms of processing circuitry—general-purpose microprocessors, CPUs, digital signal processors (DSPs), network processors, GPUs, field programmable gate arrays (FPGAs), programmable logic devices (PLDs), or similar. This circuitry may be controlled by software, firmware, or a combination thereof, possibly alongside non-processor circuits to achieve the desired functionality. Specific tasks can also be handled by state machines or one or more application-specific integrated circuits (ASICs) that implement dedicated logic. In some cases, a hybrid approach may be adopted. Additionally, implementations can include a non-transitory computer-readable storage medium that stores computer-readable instructions. When executed by a device containing suitable processing circuitry, these instructions cause the system to perform the methods or algorithms described in this disclosure. Non-limiting examples of such storage media include hard disks, optical disks, magnetic devices, read-only memory (ROM) and its variants, flash memory, or other persistent/semi-persistent storage. Once stored, these instructions enable execution of the disclosed methods.

### Unix Pipes

Unix pipes are a fundamental feature of Unix and Unix-like operating systems, enabling seamless Inter-Process Communication (IPC) by allowing the output of one process to be used as the input for another. This concept embodies the core Unix philosophy of building small, modular tools that can be combined to solve complex problems. In essence, a Unix pipe establishes a unidirectional communication channel between two processes, where one process writes data to the pipe, and the other reads it. Internally, the operating system kernel manages this channel as a buffer, ensuring reliable data transfer. Typically, pipes are created using the pipe() system call in the C programming language, which returns two file descriptors: one for the write end and the other for the read end of the pipe. Pipes are integral to Unix systems, supporting anonymous pipes (used primarily for communication between related processes, such as a parent and child) and named pipes or First In, First Out (FIFO) (special files that allow communication between unrelated processes).

A common use of Unix pipes is on the command line, where the vertical bar symbol (|) connects the output (stdout) of one command to the input (stdin) of another. For example, in the command ls -l |grep “.txt”|wc -l, the output of ls -l (a detailed file list) is piped into grep, which filters lines containing .txt, and the result is then piped into wc -l, which counts the number of filtered lines. This modular approach simplifies complex workflows without the need for intermediate storage. Beyond shell scripting, pipes are widely used for IPC in programming. For instance, a parent process can create a pipe to communicate with its child process. In such cases, the parent writes data into the pipe, and the child reads it (or vice versa), making pipes an effective and efficient mechanism for collaboration between processes.

Unix pipes are especially useful for enabling real-time streaming, parallel processing, and modular data handling. For example, they can be used to stream log files through tools like grep or awk to filter and analyze data, or to process video or audio in real-time by chaining specialized commands with applications like ffmpeg. Additionally, they support parallelism, as each stage of the pipeline runs in its own process, and the Unix kernel efficiently manages data transfer between them using shared memory. Pipes are highly efficient because they operate in memory, avoiding the slower intermediate step of writing and reading from disk.

That said, Unix pipes have some inherent limitations. They are unidirectional, meaning data flows in one direction only. For bi-directional communication, developers must use separate pipes or other IPC mechanisms. Pipes also have a fixed kernel-managed buffer size, which can cause the pipe to block if one process produces data faster than the other can consume it. Furthermore, pipes are inherently transient; they exist only as long as the processes connected to them are running, and managing more complex scenarios may require additional tools or mechanisms.

In conclusion, Unix pipes are a simple yet powerful feature that allows processes to cooperate by passing data directly between them. Whether used in shell commands, programming, real-time data processing, or parallel computing, pipes exemplify the Unix design philosophy of combining small, focused tools into larger, more powerful workflows. Their simplicity, efficiency, and versatility make them a cornerstone of Unix systems, despite their limitations, and they continue to be a vital tool for developers and system administrators alike.

Linux pipe-based asynchronous applications leverage the power of Unix pipes and non-blocking Input/Output (I/O) to create highly efficient, event-driven systems suited for real-time and scalable workloads. Again, pipes, as a core IPC mechanism in Linux, provide a unidirectional data channel that allows related processes, such as a parent and child, to exchange data seamlessly. When combined with asynchronous capabilities, such as those provided by APIs like poll() and select(), these applications can monitor multiple pipes and other input/output streams simultaneously without blocking execution. This asynchronous design is particularly valuable in scenarios where an application must handle significant volumes of data or respond to input in real time, as it prevents the system from wasting resources by idling during I/O operations. Instead, the application focuses on active tasks while efficiently reacting to events from multiple pipes or data streams.

Many widely used open-source libraries, such as libevent, construct event-driven architectures utilizing this asynchronous pipe model. For example, in a logging system or message broker, asynchronous pipes allow live data to stream between components without delay, enabling real-time filtering, aggregation, or analysis of large data sets. Similarly, in web servers or proxies, asynchronous communication allows multiple simultaneous connections to be processed efficiently, with each connection being managed as an event in a non-blocking loop. These asynchronous applications are also essential in high-performance systems, such as event-driven microservices, where responsiveness and concurrency are critical for scalability and low latency. By leveraging the capabilities of Linux pipes, such applications benefit from the modularity and simplicity of the Unix model, while event-driven programming ensures effective multitasking and system resource optimization. Linux pipe-based asynchronous applications thus form the backbone of modern, scalable, event-driven software solutions.

### Unix Pipe Emulation

As described, Unix-like systems include the pipe() API in the C programming language, which provides a straightforward and efficient way to establish a private communication channel between processes or threads. Specifically, this API enables IPC by creating a unidirectional data channel that can be used by a parent process and its child, or by two threads within the same process. Once the pipe is successfully created, it provides two file descriptors: one dedicated to reading data and the other to writing data. These descriptors can subsequently be used with standard system calls like read() and write() to exchange data seamlessly. Unix pipes represent a foundational IPC mechanism and possess four notable characteristics. They are unidirectional, reliable, secure, and asynchronous. Among these, the asynchronous nature of Unix pipes is particularly significant for the development of real-time systems. By enabling non-blocking communication, applications can use event-driven APIs like poll() or select() to efficiently handle multiple events or data streams without being forced to wait for data availability. This capability makes Unix pipes a critical component in scalable, asynchronous software systems, and they are widely employed by open-source libraries such as the popular libevent. These libraries capitalize on the asynchronous behavior to build high-performance, event-driven Linux-based applications.

A notable challenge arises, however, when these Linux systems and applications, particularly those that rely heavily on asynchronous pipes, need to be ported to the Windows operating system. While Windows does offer robust support for named pipes, including features like asynchronous I/O and built-in security, it falls short in providing equivalent functionality for unnamed Portable Operating System Interface (POSIX)-style pipes. Specifically, Windows' unnamed pipes lack the asynchronous capabilities essential for event-driven designs and real-time systems. As a result, the typical Unix-like pipe() functionality cannot be directly mapped or efficiently supported using the existing Windows APIs, creating a significant compatibility gap for cross-platform development—especially for libraries like libevent, which rely on portable, asynchronous IPC mechanisms.

To address this limitation, a novel solution is proposed which leverages local Transmission Control Protocol (TCP)/Internet Protocol (IP) connections over the loopback interface to emulate Unix-style pipes on Windows. This approach works by creating a temporary TCP listening socket in the Windows environment to simulate the behavior of a pipe. The application first initiates a short-lived TCP listening socket and then establishes a connection to it using a client-side socket. Once the client socket successfully connects to the listening socket, the listening socket is closed, leaving behind two active file descriptors including one for writing and one for reading, mimicking the behavior of a unidirectional pipe. Critically, this emulation enables the use of asynchronous (non-blocking) functionality, which is a key requirement for cross-platform event dispatching libraries like libevent.

To ensure the security of this emulated pipe, the design incorporates a Windows TCP port reservation method. The application works within a reserved TCP port range, ensuring that the temporary listening socket binds only to designated, secure ports. During the connection setup, the listening socket validates the connecting socket to confirm that it is using a port within the reserved range. If the incoming connection originates from a port outside this range, it is immediately rejected, thereby preventing potential hijacking or unauthorized access by external processes. This added layer of security emulates the private and secure nature of Unix pipes while leveraging standard TCP/IP mechanisms available in Windows.

This setup, which combines TCP socket programming and port reservation, successfully replicates the four essential characteristics of Unix pipes on Windows which are unidirectionality, reliability, security, and asynchronous operation. To further simplify the development of cross-platform software, the solution introduces a lightweight library called zpipelib. This library provides a unified zpipe API that abstracts away platform-specific implementation details. For Linux systems, the zpipe API maps directly to the native pipe() system call, maintaining the optimal performance and simplicity of Unix pipes. For Windows systems, however, the zpipe API uses the described TCP-based emulation layer as a “shim” implementation. This abstraction ensures that developers can write code once and run it on both platforms without modification or concern for the underlying implementation differences.

In summary, this approach enables full emulation of Unix-style pipes on Windows, overcoming the constraint of Windows' unnamed pipes and offering seamless asynchronous capabilities essential for scalable and event-driven systems. By introducing zpipelib, developers are empowered to build truly portable applications for Linux and Windows without sacrificing functionality, performance, or security. This solution bridges a key gap in cross-platform development and opens up new possibilities for using event-driven architectures on Windows with minimal overhead.

### Unix Pipe Emulation for Cloud-Based Systems

In a cloud-based system offering comprehensive security services at scale, the emulated pipe system described herein becomes an indispensable tool for enabling secure, efficient, and asynchronous communication between various components. By emulating Unix-style pipes using local TCP/IP connections over the loopback interface, the system provides a reliable and isolated communication mechanism that supports real-time data processing, modular service architecture, and cross-platform compatibility. This design is particularly well-suited for modern cloud security platforms, which must dynamically process large data volumes, deliver low-latency responses, and maintain strict isolation between tenants and microservices. For instance, in real-time threat analysis workflows, emulated pipes facilitate the seamless transfer of data, such as logs or network packets, from data ingestion services to analytical engines. These engines can process the data in real time, applying pattern recognition, rule-based scanning, or AI-driven algorithms to identify threats like malware, unauthorized access, or anomalous activities. The asynchronous nature of the pipe system ensures that data-intensive tasks do not block other operations, allowing pipelines to scale horizontally and distribute workloads efficiently.

Emulated pipes can also be critical in scalable logging and auditing systems, where they can be used to stream operational logs, user activities, and event data to a centralized log processing service. Instead of relying on intermediary tools like message brokers, which can introduce latency and additional overhead, emulated pipes directly transport logs in real time from microservices to the auditing backend. This enables on-the-fly log filtering, aggregation, and storage of compliance-related events, ensuring audit trails are preserved with minimal latency. The secure design of the loopback interface ensures that logs are never exposed externally, significantly minimizing potential attack surfaces and protecting sensitive information within the cloud infrastructure. Moreover, the inherent scalability of the pipe system allows multiple services to interface with the same backend without exhausting resources, making it well-suited for complex cloud ecosystems with extensive operational footprints.

Inter-process communication between security microservices is another area where the present emulated pipes can be implemented. Modern security platforms are typically built as collections of independently functioning microservices, each responsible for specific tasks such as encryption, intrusion detection, user authentication, access control, and firewall enforcement. These microservices need to share data and interact dynamically to provide coordinated responses to security threats. For instance, an intrusion detection service flagging suspicious activities can communicate with a firewall service via an emulated pipe to dynamically update its rules or block specific IP ranges in real time. The use of pipes ensures that these communications are fast, isolated, and secure, even as the number of interacting microservices grows. Furthermore, by leveraging reserved TCP port ranges within the pipe emulation framework, tenant-specific microservices in multi-tenant cloud systems can be isolated from one another, ensuring strict data compartmentalization and preventing cross-tenant interference. Any unauthorized access attempts to the reserved ports are automatically detected and dropped by the pipe shim library, ensuring that only trusted communications are permitted.

Event-driven architectures for alerting and automation workflows also benefit significantly from the emulated pipe system. In security platforms, events like unauthorized login attempts, misconfigurations, or potential data breaches need to trigger real-time alerts or actions. Emulated pipes act as lightweight, asynchronous conduits that allow event data to be transferred between monitoring services and notification systems without delay. For example, a monitoring service can generate high-priority alerts and stream them via a pipe to a notification service, which processes the data and dispatches alerts via email, direct messages, or dashboards. These workflows ensure high responsiveness to critical events and enable automated mitigation strategies, such as triggering access restrictions, initiating incident response protocols, or applying security patches. The scalability of the pipe system allows such workflows to handle thousands of events simultaneously, ensuring the platform remains resilient even under heavy loads.

Additionally, the emulated pipes play a vital role in workflows requiring data transformation, encryption, and compliance with regulatory requirements. Sensitive data ingested from client systems or applications can be securely streamed between components, for example, from an ingestion service to an encryption module, without the risk of exposing the data outside the local system. The loopback interface ensures that all transfers occur securely within the machine, minimizing the risk of interception or unauthorized access. This capability is particularly valuable for cloud platforms handling healthcare records, financial transactions, or personal data, where ensuring data protection is both a legal and business imperative. Encrypted data can then be streamed directly to secure storage backends, avoiding unnecessary intermediate steps or additional storage of unencrypted data, thereby streamlining workflows and reducing risk.

During large-scale events like Distributed Denial of Service (DDoS) attacks, the emulated pipe framework supports high-throughput analysis and mitigation efforts. In such scenarios, network traffic is intensely scrutinized for malicious patterns and metadata, requiring rapid response times to filter out bad traffic while allowing legitimate requests to flow. The emulated pipes enable data from network sensors or traffic monitors to be streamed efficiently to mitigation engines, which analyze headers, payloads, and request rates to identify and block suspicious behavior. As the system is built on asynchronous workflows, pipes allow real-time data processing without bottlenecks, ensuring that even massive traffic surges are handled gracefully. Modules functioning as rate limiters, caching proxies, or IP blocking systems can leverage the pipe infrastructure to interact with analytics and decision-making services dynamically, mitigating threats while maintaining the performance of legitimate traffic flows.

Finally, the emulated pipes are invaluable in enabling robust debugging, monitoring, and testing capabilities within cloud-based security platforms. During development or scaled deployments, engineers can create temporary pipes to simulate data transfers and test failure scenarios without impacting live operations. In production, monitoring tools can use pipes to collect live metrics and telemetry from various services, facilitating health checks, performance monitoring, and alerting on anomalous behaviors. This ensures that the system remains resilient, with bottlenecks or issues detected and resolved proactively. By coupling lightweight communication with strong isolation and flexibility, emulated pipes reduce complexity in constructing and maintaining reliable cloud-based security solutions.

In summary, the emulated pipe system provides a versatile, secure, and scalable framework for communication within cloud-based security services. By emulating Unix-style pipes with enhancements for cross-platform compatibility and isolation, it enables real-time threat detection, scalable logging, inter-process communication, compliance workflows, and resilient event-driven architectures. Whether used in multi-tenant isolation, high-throughput DDoS mitigation, or secure data transformation, the pipe system empowers cloud security platforms to deliver efficient, reliable, and modular services tailored to address the demands of large-scale and high-performance security operations.

### Emulated Unix Pipe Features

The features of the invention present a collection of innovative solutions designed to emulate Unix-style pipes on Windows systems while ensuring security, portability, and seamless cross-platform functionality. A first feature involves mapping traditional Unix pipes to local TCP/IP connections through the Windows socket API. This solution utilizes the loopback interface (for example, 127.0.0.1) to establish an emulated unidirectional data channel between two endpoints, effectively reproducing the behavior and properties of Unix pipes for use in environments lacking native POSIX pipe functionality. By leveraging standard Windows networking components, including client and server sockets, this feature supports asynchronous communication and integrates smoothly with event-driven libraries like libevent. Furthermore, the reliability and scalability of TCP/IP make it an ideal transport mechanism to provide robust data transfer in the emulated pipe.

A second feature introduces a built-in, firewall-like security mechanism by adopting a TCP port reservation method. This security feature acts as a safeguard by reserving a specific range of TCP ports that can only be used by the application. During the creation of a pipe, the listening socket verifies that any incoming connection originates from within the reserved port range. Any connection attempt that falls outside the designated range is automatically rejected, ensuring that the communication channel remains private and secure. This mechanism protects against unauthorized or malicious access, effectively mimicking the inherent security provided by traditional Unix pipes while mitigating potentially exploitable vulnerabilities in TCP/IP-based communication.

A third feature introduces a lightweight shim library layer called zpipelib to provide developers with a unified API for building cross-platform applications targeting both Linux and Windows. On Linux systems, the library maps its API directly to the native pipe() system call, preserving the simplicity, efficiency, and performance characteristics of traditional Unix pipes. On Windows, the same API is mapped to the emulation layer that uses TCP sockets, seamlessly abstracting the underlying complexity from the developer. This unified approach eliminates the need for platform-specific coding or adaptation, ensuring that developers can write once and deploy across multiple operating systems without compromising functionality or performance. As such, zpipelib simplifies cross-platform development and facilitates the adoption of event-driven programming patterns for scalable, real-time applications.

Based thereon, the features of this invention collectively address the challenges of replicating Unix-style pipes on Windows while enhancing security, usability, and cross-platform compatibility. The use of TCP/IP connections ensures reliable and asynchronous communication that mirrors traditional Unix pipe functionality. The built-in TCP port reservation mechanism provides strong security protections, maintaining the private channel characteristics of native pipes. Finally, the introduction of the zpipelib library fosters effortless portability by offering a consistent and developer-friendly interface for Linux and Windows applications alike. Together, these features provide a robust, practical, and versatile framework for modern cross-platform system design.

### Emulated Unix Pipe Components

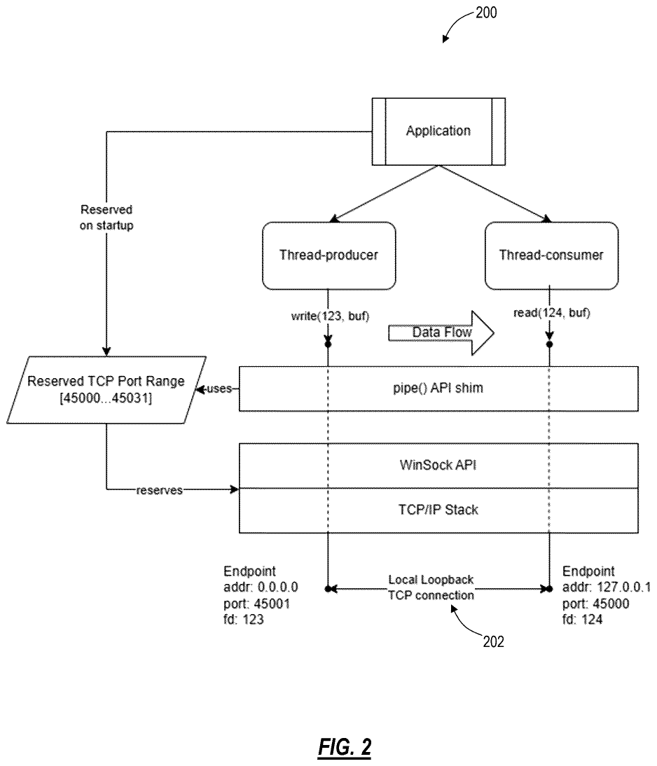

FIG. 2 is a diagram representing components of an emulated Unix pipe 200. The components of an established pipe include two file descriptors that represent the endpoints of the communication channel and enable data exchange between two threads or processes. In this setup, the pipe is implemented over a local TCP/IP loopback connection 202, which uses the system's network stack to facilitate communication via two bound endpoints. Each endpoint is associated with a specific TCP port, which is allocated from a pre-reserved range of ports. For example, in a demonstration scenario, the file descriptors fd 123 and fd 124 correspond to the two ends of the pipe, allowing one thread to write data to the pipe while the other reads it. The TCP connection 202 underlying the pipe operates between two specific ports, such as source port 45000 and destination port 45001. These ports are dynamically allocated from a reserved TCP port range [45000, 45031], which is designated exclusively for the application to prevent external interference. This reservation ensures security and eliminates the risk of malicious processes or unexpected network activity hijacking the communication channel.

It is important to note that the specific file descriptors and port numbers shown in this example, such as fd 123, fd 124, 45000, and 45001, are for illustrative purposes only. In a real-world deployment, these values would be assigned dynamically by the operating system based on availability. The operating system handles the assignment of file descriptors to ensure proper routing of read and write operations to their respective endpoints, while the TCP stack manages the port allocations within the reserved range to maintain security and resource isolation. This dynamic assignment enables the system to support multiple pipes simultaneously, as each pipe operates on a distinct pair of file descriptors and TCP ports.

In the context of this design, the local loopback interface is used to route data exclusively within the host machine, ensuring low latency and bypassing external network interfaces. By utilizing this method, the pipe effectively replicates Unix-style pipe behavior while adding the robustness and flexibility of TCP/IP for use in environments, such as Windows systems, where POSIX pipes are not natively supported. Through this combination of file descriptors, reserved TCP ports, and the localhost interface, the established pipe provides reliable, unidirectional, and secure communication between threads or processes. This technical foundation supports scalability and asynchronous event-driven programming while maintaining the core characteristics expected of Unix pipes.

### Pipe Shim Library Initialization

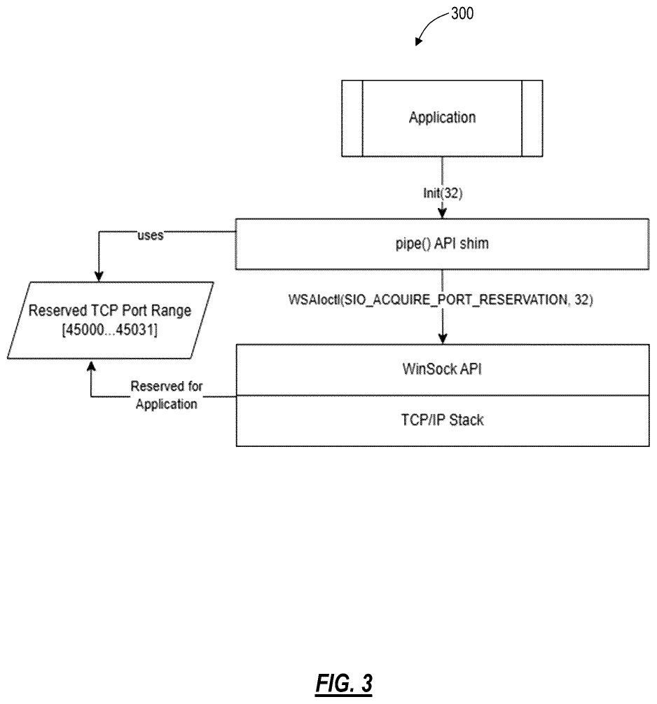

FIG. 3 is a flowchart representing a process 300 for pipe shim library initialization. During its startup, the application initializes the pipe shim library by invoking the Init() API, which takes as a parameter the maximum number of pipes that the application intends to support concurrently. This initialization process establishes the foundation for the secure and efficient operation of pipes by reserving a dedicated range of TCP ports for use in pipe creation. Specifically, the shim library leverages the system-provided Winsock API to reserve a TCP port range of the required size, corresponding to the maximum number of pipes the application has specified. For example, if the application determines that it may need up to 32 pipes at any given time, the library will reserve a range of 32 contiguous TCP ports. This port reservation ensures that only the application can use this range, preventing any other process on the system from reserving or binding to any of the TCP ports within the designated range.

The advantage of this reserved range is that it guarantees exclusive access to these ports for the application, ensuring secure and predictable communication channels for the emulated pipes. By precluding other processes from interfering with this port range, the system eliminates the risk of resource conflicts or malicious entities hijacking the pipe communication. Additionally, this method allows the shim library to dynamically allocate ports from the reserved range during the creation of pipes, preserving the integrity of the application's operation while avoiding clashes with the broader network stack.

It is important to note that the specific TCP port range used in this process is determined dynamically by the operating system and depends on resource availability at runtime. While for demonstration purposes a fixed range, such as [45000, 45031], may be shown, in real-world scenarios, both the starting port and length of the range are system-assigned variables. The actual length of the range, however, is explicitly chosen by the application during the Init() call, based on its expected workload and concurrency requirements.

Once the TCP port range has been successfully reserved and initialized, the application is ready to begin creating pipes. Each pipe will utilize a port pair from the reserved range and allocate file descriptors for the read and write endpoints. This initialization step ensures that the environment is prepared for secure, reliable, and efficient operation, allowing the application to fully leverage the emulated pipe functionality. By delegating the port reservation process to the shim library during initialization, developers can rely on a streamlined and robust setup without requiring direct intervention in managing TCP socket resources.

### Pipe Setup Sequence

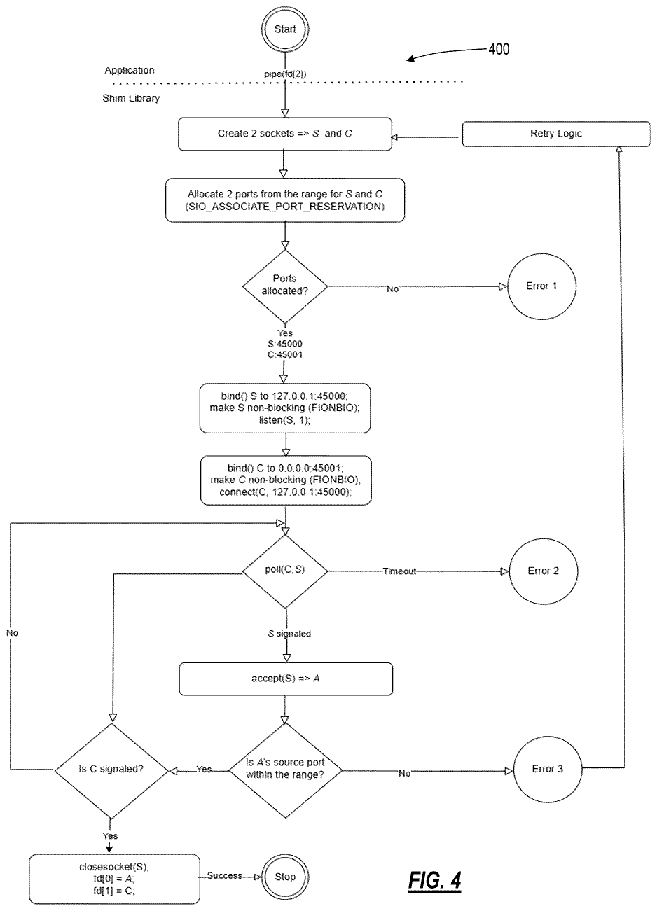

FIG. 4 is a flow diagram representing a pipe setup sequence 400. The pipe setup sequence 400 is a critical process managed by the shim library to establish a secure and reliable communication channel that emulates Unix-style pipes via local TCP sockets. The sequence begins with the shim library creating two TCP sockets, one designated as the client socket (C) and the other as the server socket(S). These sockets are dynamically bound to two distinct ports that are allocated from the pre-reserved TCP port range established during the library's initialization (as described in the pipe shim library initialization step). Once the two sockets are successfully created and bound to their respective ports, the library establishes a local loopback TCP connection between them, routing data exclusively within the host machine for low latency and secure communication. After the connection is established, the library assigns file descriptors to represent the client socket (C) and an accepted socket (A) created from the server socket's listener. These file descriptors are returned to the application as the result of the pipe() system call, serving as the read and write handles for the pipe.

A key optimization in this process involves immediately closing the server socket (S) after the connection is established. This step is important because it frees up system resources and eliminates the presence of an open listening port, reducing the exposure of the application to potential unwanted or unauthorized connections. By doing so, the shim library enhances security while maintaining the simplicity and effectiveness of the setup.

Despite the structured nature of the pipe setup sequence, several runtime errors can occur during the process, each of which must be handled appropriately to ensure the proper functioning of the pipe. Error-1 represents a scenario where the system runs out of available ports in the reserved range, caused by the application attempting to create too many pipes simultaneously. When this error occurs, the shim library can handle it in one of two ways depending on its implementation. It may treat the error as fatal, notifying the application and terminating the process, or it may handle it as retriable, mitigating the issue by extending the reserved port range dynamically to accommodate additional pipes.

Error-2 occurs when the loopback TCP connection cannot be established. This issue may arise due to firewall software or system security policies blocking traffic over the loopback interface. In such cases, the connection setup fails, and the application must either configure the internal firewall to allow loopback connections for the application's reserved port range or seek administrative intervention to adjust the system's security settings. Proper documentation or user instructions for configuring firewalls may be necessary to mitigate this error in a production environment.

Finally, Error-3 represents a scenario where the shim library detects that some other process is attempting to communicate with the listening server socket(S). This might indicate a potential hijacking attempt or an unintentional conflict with another process. The shim library responds to this situation by immediately dropping the unauthorized connection to maintain the private and secure nature of the pipe. This type of error is considered retriable, and the library can handle it by implementing retry logic. The retry mechanism involves closing all related sockets, server (S), client (C), and acceptor (A), and repeating the entire setup sequence from the beginning to establish a clean connection. This ensures that the error state is resolved without compromising the pipe's security or functionality.

In summary, the pipe setup sequence is a carefully designed process that uses TCP sockets and the local loopback interface to emulate Unix pipes while prioritizing resource efficiency, performance, and security. The sequence ensures that the application receives two file descriptors corresponding to the endpoints of a secure communication channel and immediately cleans up any unnecessary resources, such as the server socket. By anticipating and handling runtime errors, such as port exhaustion, firewall restrictions, or unauthorized connection attempts, the shim library provides resilience and reliability, enabling the application to deploy robust, cross-platform communication mechanisms.

### Unix Pipe Emulation Process

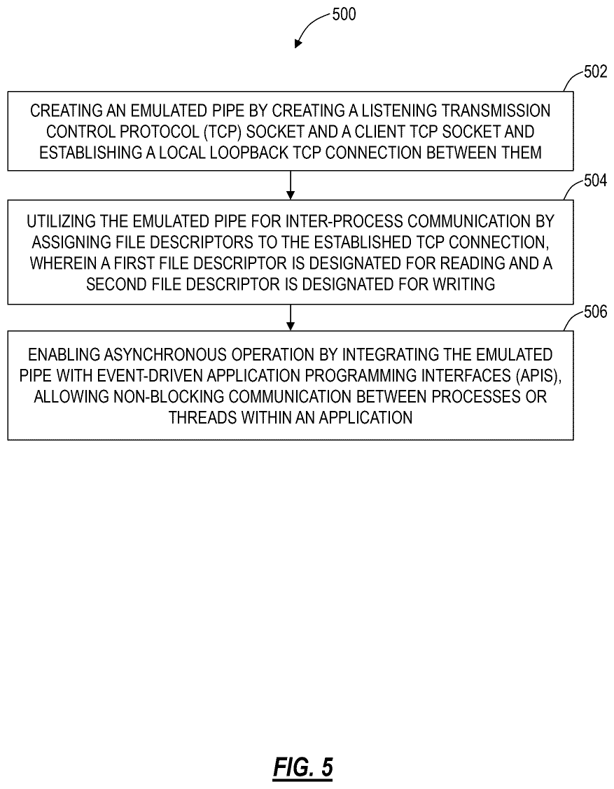

FIG. 5 illustrates a flowchart of a process 500 for emulation of Unix pipes in windows systems. In various embodiments, the process 500 can be implemented in multiple ways: as a method comprising distinct steps, via the computing system 100 configured to execute those steps, via a cloud system configured to do so, or through a non-transitory computer-readable medium that stores instructions causing one or more processors to perform the steps. This flexibility allows process 500 to be adapted to various system architectures and deployment scenarios. The process 500 includes creating an emulated pipe by creating a listening Transmission Control Protocol (TCP) socket and a client TCP socket and establishing a local loopback TCP connection between them (step 502); utilizing the emulated pipe for inter-process communication by assigning file descriptors to the established TCP connection, wherein a first file descriptor is designated for reading and a second file descriptor is designated for writing (step 504); and enabling asynchronous operation by integrating the emulated pipe with event-driven Application Programming Interfaces (APIs), allowing non-blocking communication between processes or threads within an application (step 506).

The process 500 can further include configuring security measures by reserving a dedicated range of TCP ports and validating incoming connections to ensure they originate from the reserved port range. The reserved TCP port range can be dynamically allocated at runtime based on system availability. The listening TCP socket can be closed after the client TCP socket successfully connects, preventing unwanted external connections. The local loopback TCP connection can be established using a Windows Sockets API. The steps can include implementing a retry mechanism to handle failed connection attempts by reinitializing the emulated pipe with a new TCP port allocation. The steps can include encrypting data transmitted over the emulated pipe to enhance security. The event-driven API used for enabling asynchronous operation can include select() or poll() mechanisms. The steps can include dynamically binding the client TCP and listening TCP sockets to distinct ports selected from a pre-reserved TCP port range to ensure predictable and controlled communication. The steps can include detecting an unauthorized process attempting to communicate to a listening TCP port, and dropping the connection based thereon.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for emulating a Unix-style pipe on a Windows operating system, the method comprising steps of:
creating an emulated pipe by creating a listening Transmission Control Protocol (TCP) socket and a client TCP socket and establishing a local loopback TCP connection therebetween;
utilizing the emulated pipe for inter-process communication by assigning file descriptors to the established TCP connection, wherein a first file descriptor is designated for reading and a second file descriptor is designated for writing; and
enabling asynchronous operation by integrating the emulated pipe with event-driven Application Programming Interfaces (APIs), allowing non-blocking communication between processes or threads within an application.

2. The method of claim 1, wherein the steps include configuring security measures by reserving a dedicated range of TCP ports and validating incoming connections to ensure they originate from the reserved port range.

3. The method of claim 2, wherein the reserved TCP port range is dynamically allocated at runtime based on system availability.

4. The method of claim 1, wherein the listening TCP socket is closed after the client TCP socket successfully connects, preventing unwanted external connections.

5. The method of claim 1, wherein the local loopback TCP connection is established using a Windows Sockets API.

6. The method of claim 1, further comprising implementing a retry mechanism to handle failed connection attempts by reinitializing the emulated pipe with a new TCP port allocation.

7. The method of claim 1, further comprising encrypting data transmitted over the emulated pipe to enhance security.

8. The method of claim 1, wherein an event-driven API used for enabling asynchronous operation includes select() or poll() mechanisms.

9. The method of claim 1, wherein the steps include dynamically binding the client TCP and listening TCP sockets to distinct ports selected from a pre-reserved TCP port range to ensure predictable and controlled communication.

10. The method of claim 9, wherein the steps include detecting an unauthorized process attempting to communicate to a listening TCP port, and dropping the connection based thereon.

11. A non-transitory computer-readable storage medium having computer-readable code stored thereon for programming one or more processors to perform steps of:
creating an emulated pipe by creating a listening Transmission Control Protocol (TCP) socket and a client TCP socket and establishing a local loopback TCP connection therebetween;
utilizing the emulated pipe for inter-process communication by assigning file descriptors to the established TCP connection, wherein a first file descriptor is designated for reading and a second file descriptor is designated for writing; and
enabling asynchronous operation by integrating the emulated pipe with event-driven Application Programming Interfaces (APIs), allowing non-blocking communication between processes or threads within an application.

12. The non-transitory computer-readable storage medium of claim 11, wherein the steps include configuring security measures by reserving a dedicated range of TCP ports and validating incoming connections to ensure they originate from the reserved port range.

13. The non-transitory computer-readable storage medium of claim 12, wherein the reserved TCP port range is dynamically allocated at runtime based on system availability.

14. The non-transitory computer-readable storage medium of claim 11, wherein the listening TCP socket is closed after the client TCP socket successfully connects, preventing unwanted external connections.

15. The non-transitory computer-readable storage medium of claim 11, wherein the local loopback TCP connection is established using a Windows Sockets API.

16. The non-transitory computer-readable storage medium of claim 11, further comprising implementing a retry mechanism to handle failed connection attempts by reinitializing the emulated pipe with a new TCP port allocation.

17. The non-transitory computer-readable storage medium of claim 11, further comprising encrypting data transmitted over the emulated pipe to enhance security.

18. The non-transitory computer-readable storage medium of claim 11, wherein an event-driven API used for enabling asynchronous operation includes select() or poll() mechanisms.

19. The non-transitory computer-readable storage medium of claim 11, wherein the steps include dynamically binding the client TCP and listening TCP sockets to distinct ports selected from a pre-reserved TCP port range to ensure predictable and controlled communication.

20. The non-transitory computer-readable storage medium of claim 19, wherein the steps include detecting an unauthorized process attempting to communicate to a listening TCP port, and dropping the connection based thereon.
